(19) United States
(12) Patent Application Publication
(10) Pub. No.: US 2014/0279121 A1
(43) Pub. Date: Sep. 18, 2014

(54) CUSTOMIZABLE AND ADJUSTABLE PRICING OF GAMES

(71) Applicant: BIG FISH GAMES, INC., Seattle, WA (US)

(72) Inventors: Christopher Matthew George, Seattle, WA (US); Xiaozheng Zhong, Bellevue, WA (US); Liwei Ma, Issaquah, WA (US)

(73) Assignee: BIG FISH GAMES, INC., Seattle, WA (US)

(21) Appl. No.: 13/797,024

(22) Filed: Mar. 12, 2013

(51) Int. Cl. G06Q 30/02

(52) U.S. Cl. CPC G06Q 30/0283
USPC 705/26.1

(57) ABSTRACT

One or more games may be accessed by a plurality of user devices. A current geographic location of a user device or a geographic location associated with the user device may be detected. A language associated with the one or more games and/or a type of currency of a rate associated with the one or more games may be customized based at least in part on the current geographic location and/or the geographic location. An identity of a user associated with the user device may also determined. Based at least in part on the identity of the user, the rate associated with the one or more games may be dynamically adjusted.

### BACKGROUND

Consumers may access and interact with different types of media content in a variety of ways. In particular, a consumer may purchase and/or play a game via a game console, a site, and/or a mobile device. Since each consumer has varying preferences (e.g., likes, dislikes etc.), these consumers may prefer to play different types of games. For instance, one consumer may prefer to play games relating to warfare whereas a different user may be interested in playing hidden object games. Although consumers may select games that best suit their respective preferences, it may be difficult to identify and direct consumers to games that have associated characteristics that best match the particular preferences of those consumers.

### BRIEF DESCRIPTION OF THE DRAWINGS

The detailed description is set forth with reference to the accompanying figures, in which the left-most digit of a reference number identifies the figure in which the reference number first appears. The use of the same reference numbers in the same or different figures indicates similar or identical items or features.

FIG. 1 is a diagram showing an example system including a user, a user device, one or more networks, and one or more content servers. In this system, one or more games may be provided to the users based on prior user interaction.

FIG. 2 is a diagram showing an example process of presenting one or games to a user and collecting data based on the user's interaction with the games.

FIG. 3 is a diagram showing an example process of analyzing data that represents prior user interaction by a batch processing module of a content server.

FIG. 4 is a diagram showing an example process of analyzing data that represents prior user interaction by a realtime delivery module of a content server.

FIG. 5 is a diagram showing a plurality of components used to recommend content to one or more users.

FIG. 6 is a diagram showing a user interface used to recommend content to one or more users.

FIG. 7 is a flow diagram showing an example process of dynamically adjusting and/or modifying the prices of content for a user.

FIG. 8 is a flow diagram showing an example process of customizing the presentation of content based on location information.

### DETAILED DESCRIPTION

This disclosure describes systems and processes for mining and/or collecting data associated with consumers and promoting games to those consumers based at least in part on the collected data. In some embodiments, systems and processes described herein may collect user preferences associated with different consumers and may also collect data relating to user interaction with one or more games and/or a site associated with those games. For instance, such data may represent which games consumers viewed, tried, downloaded, installed, purchased, and/or played, user input associated with those games, when those games were played, a location of the consumer when those games were played, and/or any other information that corresponds to a user's interactions with those games. For the purposes of this discussion, the games described above and set forth in additional detail below may include games that are played online, such as games played via a network (e.g., the Internet).

In other embodiments, based at least in part on the collected data, one or more predictive models may be generated and/or utilized to recommend the games. The predictive models may include one or more algorithms that may determine which games are most likely to be preferred by different consumers. That is, based on a consumer's prior interactions with one or more games and/or a site or application associated with those games, different games may be presented or recommended to that consumer. Moreover, the one or more predictive models may determine which games are most likely to be of interest to other consumers. As a result, by analyzing data corresponding to how information (e.g., games) is consumed by consumers, the predictive models may identify which games are most relevant to different consumers. Subsequently, those games may be directed and/or recommended to consumers in various manners.

Furthermore, once it is determined which games are mostly likely to be of interest to different consumers, those games may be directed to the consumers. For example, the games that are deemed to likely be of interest to specific consumers may be provided to consumers via e-mail or any other means for communicating information to consumers. Moreover, games may be recommended to consumers via a site (e.g., a website) when a user account associated with that consumer is recognized. Games may also be promoted to consumers via applications associated with a device of a consumer, such as a mobile device. In other embodiments, particular games may be directed to consumers via interaction with various forms of customer service (e.g., e-mail messages, telephone, SMS messages, instant messaging etc.). Therefore, based on how games and other information are consumed by consumers, the systems and processes described herein may determine which content is most likely to be of interest to different consumers and/or which content consumers are most likely to use/acquire in the future. Then, the identified content may be provided to the consumers in some manner. As a result, the most appropriate content (e.g., games) may be directed to the right consumer at the right time.

In some embodiments, the pricing of games may be adjustable and/or customizable for different consumers based on any of a variety of factors. For instance, the systems and processes described herein may adjust the price at which games can be acquired based on whether a consumer is a subscriber to a gaming service, the consumer's gaming history, etc. Additionally, when a consumer views games that may be acquired, the pricing associated with those games may be presented in a currency corresponding to a current geographic location of that consumer and/or a geographic location in which a device associated with the consumer is registered. That is, the type of currency being presented to consumers may reflect where those consumers are actually located and/or where those consumers are from.

The discussion begins with a section, entitled “Example Environment,” describing a system for recommending and/or promoting content to users and/or user devices. Next, the discussion includes a section, entitled “Presentation of Games,” that describes a system for providing games to users. A “Pricing of Games” section then follows, which describes customizable and/or adjustable pricing of games. The discussion then moves on to a “Batch Processing Module” section that describes monitoring user activity and determining correlations between various data. Next, the discussion includes a “Realtime Delivery Module” section that describes how correlation data associated with games is aggregated and stored. Then, the discussion includes an “IM Clients Module” section that describes various manners of presenting games to user devices. The discussion then moves on to a “Game Presentation User Interface” section that illustrates how the games are presented and/or recommended to users. The discussion then includes a section, entitled “Example Processes,” that illustrates and describes example processes for implementing the described techniques. Lastly, the discussion includes a brief “Conclusion.”

This brief introduction, including section titles and corresponding summaries, is provided for the reader's convenience and is not intended to limit the scope of the claims, nor the proceeding sections. Furthermore, the techniques described above and below may be implemented in a number of ways and in a number of contexts. Several example implementations and contexts are provided with reference to the following figures, as described below in more detail. However, the following implementations and contexts are but a few of many.

### Example Environment

FIG. 1 illustrates an intelligent merchandising architecture 100 in which a user 102 may electronically access content 116, such as software games, and play that content 116 on a user device 104. As described below, the user device 104 may be implemented in any number of ways, such as a computer, a laptop computer, a tablet device, a personal digital assistant (PDA), a multi-functioning communication device, and so on. The user 102 may access the content 116 over a network 106, such as the Internet, which may be communicatively coupled to one or more content server(s) 108. The content server(s) 108 may store various types of content 116, such as software games, media content (e.g., audio content, video content), and other types of content that are accessible by the user device 104. For instance, the user 102 may access and/or play the content 116 via one or more sites (e.g., a website) that are accessible via the network(s) 106. One or more processor(s) 110, a memory 112, and a display 114 of the user device 104 may enable the user 102 to access and/or play the content (e.g., games). In addition to the content 116 being stored on, and/or accessed via, the content server(s), the content 116 may also be stored directly on the user device 104.

Furthermore, one or more processor(s) 118 and a memory 120 of the content server(s) 108 may allow the content server(s) 108 to provide and/or recommend the content 116 to the user 102. More particularly, a batch processing module 122, a predictive model module 124, a realtime delivery module 126, and an intelligent merchandising (IM) client module 128 are stored in memory 120 and executed by the processor(s) 118 to enable the content server(s) 108 to recommend various content 116 to the user 102 based at least in part on prior user interaction with the content 116. For the purposes of this discussion, the content 116 may be any type of content that may be rendered, acquired, and/or consumed by the user 102, such as games, video content, audio content, etc. Moreover, in certain embodiments, the games may relate to casual gaming, which may include online games that may be played over the network(s) 106, and/or software games that may be stored on, and/or be accessible by, the user device 104.

Casual games may include games (e.g., video games) that are associated with any type of gameplay and any type of genre. Casual games may have a set of simple rules that allow a large audience to play, such games that may be played utilizing a touch-sensitive display, a telephone keypad, a mouse having one or two buttons, etc. Moreover, casual games may not require a long-term commitment or unique skills to play the game, thus allowing users 102 to play the game in short time increments, to quickly reach a final stage of the game, and/or to continuously play the game without needing to save the game. Casual games may also be played on any medium, including personal computers, game consoles, mobile devices, etc., and may be played online via a web browser. Casual games may be referred to as “casual” since the games may be directed towards consumers who can come across the game and get into gameplay in a short amount of time, if not immediately. Examples of casual games may include puzzle games, hidden object games, adventure games, strategy games, arcade and action games, word and trivia games, and/or card and board games.

Other games may first be downloaded to and/or installed on the user device 104 and/or an application associated with the user device 104. These games, and the casual games described above, may also be acquired by the user 102. Regardless of whether the games are stored on the user device 104 or the content server(s) 108, playing the games may include accessing, viewing, trying, and/or otherwise interacting with the games. However, for the purpose of this discussion, the terms content 116 and games, including casual games, may be used interchangeably.

The user 102 may access the content 116 in any of a number of different manners. For instance, the user 102 may access a site (e.g., a website) associated with an entity, such as a merchant, that provides access to the content 116. Such a site may be remote from the user device 104 but may allow the user 102 to interact with the content 116 via the network(s) 106. Moreover, the user 102 may download one or more applications to the user device 104 in order to access the content 116. In this case, the content server(s) 108 may provide, transmit, suggest, and/or recommend the content 116 to the user device 104, whereby the user 102 may interact with the content 116 via the downloaded application(s). In other embodiments, the content 116 may be streamed from the content server(s) 108 to the user device 104 such that the user 102 may interact with the content 116 in real-time. Once the user 102 accesses the content 116, the user 102 may perform a variety of actions, including learning about the content 116, viewing the content 116, trying the content 116, acquiring (e.g., purchasing, renting, leasing, etc.) the content 116, and/or downloading/installing the content 116 to the user device 104.

Additionally, the user 102 may have a user account associated with the entity that provides and/or provides access to the content 116. For instance, assuming that the content 116 is available via a website, the user 102 may have a user account that specifies various types of information relating to the user 102. This information may include personal information, user preferences, and/or some user identifier (ID), which may be some combination of characters (e.g., name, number, etc.) that uniquely identifies the user 102 from other users 102. In various embodiments, the identifier may be referred to as a master ID and may be different from each master ID that corresponds to other users 102. The master ID for each user 102 may be used to monitor actions performed by the user 102, which may then be stored as data. In some embodiments, multiple related users 102 may be associated with the same master ID and/or a single user 102 may have multiple master IDs. In other embodiments, the master IDs may be associated with one or more e-mail addresses or other identifying characteristics associated with the user 102.

In some embodiments, the user device 104 may be any type of device that is capable of receiving, accessing, and/or interacting with the content 116 (e.g., games), such as, for example, a personal computer, a laptop computer, a cellular telephone, a personal digital assistant (PDA), a tablet device, an electronic book (e-Book) reader device, a television, or any other device that may be used to access content 116 that may be viewed, tried, played, downloaded, installed, and/or acquired by the user 102. For instance, the user 102 may utilize the user device 104 to access and navigate between one or more sites, such as web sites, web pages related thereto, and/or documents or content associated with those websites or web pages that may be of interest to the user 102. For instance, the user 102 may utilize the user device 104 to access sites to view, play, and/or download the content 116. Further, the user device 104 shown in FIG. 1 is only one example of a user device 104 and is not intended to suggest any limitation as to the scope of use or functionality of any user device 104 utilized to perform the processes and/or procedures described herein.

The processor(s) 110 of the user device 104 may execute one or more modules and/or processes to cause the user device 104 to perform a variety of functions, as set forth above and explained in further detail in the following disclosure. In some embodiments, the processor(s) 110 may include a central processing unit (CPU), a graphics processing unit (GPU), both CPU and GPU, or other processing units or components known in the art. For instance, the processor(s) 110 may allow the user device 104 to access sites associated with games and/or download applications that are used to access and/or play the content 116. Additionally, each of the processor(s) 110 may possess its own local memory, which also may store program modules, program data, and/or one or more operating systems.

In at least one configuration, the memory 112 of the user device 104 may include any component that may be used to access, play, and/or download the content 116. Depending on the exact configuration and type of the user device 104, the memory 112 may also include volatile memory (such as RAM), non-volatile memory (such as ROM, flash memory, miniature hard drive, memory card, or the like) or some combination thereof.

In various embodiments, the user device 104 may also have input device(s) such as a keyboard, a mouse, a pen, a voice input device, a touch input device, etc. The user device 104 may also include the display 114 and other output device(s), such as speakers, a printer, etc. The user 102 may utilize the foregoing features to interact with the user device 104 and/or the content server 108 via the network(s) 106. More particularly, the display 114 of the user device 104 may include any type of display known in the art that is configured to present (e.g., display) information to the user 102. For instance, the display 114 may be a screen or user interface that allows the user 102 to access, play, and/or download the content 116. Further, one or more local program modules may be utilized to play the content 116 on a browser. The local program modules may be stored in the memory 112 and/or executed on the processor(s) 110 in order to present graphics associated with the content 116 on the display 114.

In some embodiments, the network(s) 106 may be any type of network known in the art, such as the Internet. Moreover, the user device 104 and the content server(s) 108 may communicatively couple to the network(s) 106 in any manner, such as by a wired or wireless connection. The network(s) 106 may also facilitate communication between the user device 104 and the content server(s) 108, and also may allow for the transfer of data or communications therebetween. For instance, the content server(s) 108 and/or other entities may provide access to the content 116 that may be accessed, played, and/or downloaded utilizing the user device 104.

In addition, and as mentioned previously, the content server(s) 108 may include one or more processor(s) 118 and a memory 120, which may include the content 116, the batch processing module 122, the predictive modules module 124, the realtime delivery module 126, and the IM clients module 128. The content server(s) 108 may also include additional components not listed above that perform any function associated with the content server(s) 108. In various embodiments, the content server(s) 108 may be any type of server, such as a network-accessible server, or the content server(s) 108 may be any entity that provides access to the content 116 that is stored on and/or is accessible by the content server(s) 108.

As mentioned previously, the content server(s) 108 may provide access to the content 116 (e.g., games) that may be viewed, played, and/or downloaded by the user 102 of the user device 104. The user 102 may access the content 116 in different manners, such as by visiting a site (e.g., a website) and/or downloading or installing an application to the user device 104. Upon accessing the content 116, the user 102 may interact with the content 116 and/or the site/application associated with the content 116, such as by viewing, trying, playing, downloading, installing, and/or acquiring the content 116. In response, the content server(s) 108 may be configured to track and monitor actions taken by the user 102. For instance, the content server(s) 108 may monitor and store user searches of certain content 116, browsing activity, the extent to which users 102 access the content 116, user purchases, user downloads, any trends associated with the user 102 and the content 116 that the user 102 interacts with, user interaction with a content catalog, data associated with applications downloaded by the user 102 (e.g., what was installed, sessions, time spent playing, etc.), data associated with browser history and/or cookies, data provided by the user 102, e-mail click data, and/or any other data that indicates preferences of the user 102.

In various embodiments, the batch processing module 122 of the content server(s) 108 may track any activity by the user 102, regardless of whether the user device 104 associated with the user 102 is online or offline. This activity may be automatically captured while the user is online (e.g., connected to the network(s) 106). If the user 102 is currently offline, the batch processing module 122 may collect data that represents such activity when the user 102 becomes online. For example, the batch processing module 122 may determine which games the user 102 is accessing and any other interaction with the content provided by the content server(s) 108. As a result of capturing this user activity data, the batch processing module 122 may determine the viewing, playing, downloading, installing, and/or purchasing behavior of the user 102. In other embodiments, the data being collected by the batch processing module 122 may be provided directly from the user 102. For example, the user 102 may provide information about the user 102 in a user profile, which may include personal information about the user 102, user preferences with respect to games, genres of games, etc.

In some embodiments, the predictive model module 124 of the content server(s) 108 may analyze the collected data and generate one or more predictive models. The predictive models may be utilized to determine relationships and correlations between prior user interaction with the content 116 and other content 116 that may be provided by the content server(s) 108, including specific games and/or different genres of games. For example, based on user activity associated with the content 116, the predictive model may predict which other content 116 are likely to be of interest to that user 102. As a result, the content 116 that are provided, presented, and/or recommended to users 102 may be targeted to each user 102. This way, there may be a higher likelihood that the recommended content 116 may be subsequently viewed, played, and/or downloaded by the users 102.

Furthermore, the collected data may be stored by the batch processing module 122 and the predictive model module 124 may then utilize the data to create the one or more predictive models. For the purposes of this discussion, the predictive models may be used in attempt to predict the probability of an outcome given a set of input data. That is, the predictive models may predict which content 116 are likely to be of interest to a particular user 102 based at least in part on user activity data associated with that user 102 and/or user activity data associated with other users 102. For instance, in response to tracking activity of a particular user 102 (e.g., games searched, browsed, played, downloaded, installed, etc.), the combination of the batch processing module 122 and the predictive models module 124 may determine correlations between that data and other content 116 that are related to or otherwise associated with that data. The data generated by the batch processing module 122 and utilized by the predictive model module 124 may then be output to the realtime delivery module 126 as one or more data files.

In various embodiments, the realtime delivery module 126 may process the data files to determine which content 116 are likely to be of greater interest to the user 102. The data files may represent correlations between a master ID associated with the user 102 to various content 116, which may be represented by a game ID. The data files may also represent correlations between game IDs and other games, genre IDs and games, and/or users 102 that are first time customers and games. The data files and other data may be stored in one or more databases associated with the realtime delivery module 126. Based at least in part on the correlations described above, the realtime delivery module 126 may identify which games should be presented to different users 102.

As a result of the processing by the batch processing module 122 and the realtime delivery module 126, the content 116 that are presented and/or recommended to the user 102 may be personalized based at least in part on their prior interactions with various content 116 and the content server(s) 108. In various embodiments, the content 116 that are predicted to be of greater interest to a particular user 102 may be presented to the user 102 via different mediums. For example, the recommended content 116 may be presented when the user 102 accesses a site (e.g., a website) associated with the content 116. That is, when the user provides a master ID or some other identifying characteristic(s), the IM clients module 128 may recommend content 116 that are predicted to be of interest to the user 102. Moreover, content 116 may be recommended to a user 102 via an application that is accessed by, or downloaded to, the user device 104. Alternatively, the content 116 recommended to the user 102 may be provided via an e-mail message, an SMS message, a telephone call, an instant message, or any other means of communicating information to the user 102. Moreover, the recommended content 116 may be provided to the user 102 in response to a user-initiated communication, such as the user 102 contacting customer service, and/or the content 116 may be presented to the user 102 at any time without receiving any request from the user 102. For the purposes of this discussion, the IM clients module 128 may be interchangeably referred to as a communication module or a recommendation module.

As a result, the content server(s) 108 may monitor and track any type of activity associated with the user 102 and store this data for subsequent analysis. One or more predictive models may then determine, based at least in part on the collected data, which content 116 are most likely to be of interest to the user 102. The content server(s) 108 may then provide this content 116 to the user 102. Since the content 116 that are directed to the user 102 may be personalized based on the user's 102 prior actions, there may be a higher likelihood that the user 102 will view, try, play, install, download, and/or acquire this content 116.

### Presentation of Games

FIG. 2 illustrates a system 200 that relates to presenting one or more games to a consumer. In some embodiments, the user 102 may utilize a user device 104 to access one or more games 202 (e.g., software games, online games, casual games, etc.). The games 202 may be provided by the content server(s) 108 and may be accessed via a site (e.g., a website), an application downloaded to the user device 104, and/or the games 202 may be streamed from the content server(s) 108 to the user device 104 in real time. In any event, when the user 102 accesses the games 202, the user 102 may have the option to install and play 204 the games 202, to view 206 the games 202, to try 208 the games 202, and/or to acquire 210 (e.g., purchase, lease, rent, etc.) the games 202. For instance, the user 102 may access a website associated with a merchant that provides access to the games 202. The user 102 may then take one or more of the foregoing actions based on the user's 102 interest in those games 202.

In some embodiments, the user 102 may be sufficiently interested in at least one of the games 202 to install and/or play 204 the game 202, such as by interacting with the game 202 pursuant to the rules of the game 202. The content server(s) 108 may allow unlimited play of the game 202 or may limit the extent to which the user 102 may play 204 the game 202. Since the content server(s) 108 may be configured to track user interaction with respect to the one or more games 202, the content server(s) 108 may determine that the game 202 has been installed 204 on the user device 104. The content server(s) 108 may also track any information associated with the user 102 playing 204 the game 202. For instance, the content server(s) 108 may track the starting times of play 204, the duration of play 204, the frequency of play 204, scores and/or other metrics associated with the play 204, any information associated with the content of the game during play 204, etc. Such data may be tracked and collected each time the user 102 plays 204 the game 202 and then be stored in and/or analyzed by a processing database 212. As will be discussed in greater detail with respect to FIGS. 3-6, the processing database 212 may output data files 214 that represent user interaction and play 204 of the games 202.

In other embodiments, when the user 102 accesses at least one of the games 202, the user 102 may choose not to play 204 the game 202 at that time. Instead, the user 102 may choose to view 206 the game 202 in order to learn about the game, to determine if the user 102 would like to play 204 the game 202, etc. For instance, the user 102 may read text that provides information (e.g., a summary) about the game 202, view a simulation of how the game 202 is played, and/or view a simulation of the game 202 itself. The content server(s) 108 may store data representative of user viewing 206 of the games 202 in the processing database 212. Moreover, the processing database 212 may output one or more data files 214 that represent user interaction and viewing history 206 associated with the games 202.

Furthermore, as opposed to playing 204 or viewing 206 one of the games 202, the user 102 may try 208 the game 202. That is, for little or no charge, the content server(s) 108 may allow the user 102 to try 208 playing the game for a limited amount of time and/or a limited number of times. This may enable the user 102 to determine whether he/she would like to subsequently play 204 and/or purchase 210 the game 202. Further, the content server(s) 108 may track when the user 102 tries 208 one of the games 202 and store this data in a download database 216. The data stored in the download database 216 may be further analyzed by the predictive models to determine which games 202 may also be of interest to the user 102.

In various embodiments, the user 102 may also acquire 210 at least one of the games 202, such as by purchasing, leasing, renting, or otherwise acquiring the game 202. Once the user 102 has acquired 210 the game 202, the content server(s) 108 may allow unlimited access to the game 202 or place restrictions relating to the amount the user 102 may interact with the acquired game 202. Moreover, the content server(s) 108 may track the game purchase history of each user 102, which may include data such as the identity of the acquired games 202, when the games 202 were acquired 210, the amount paid for the acquired games 202, and/or any other information relating to the acquisition 210 of games 202. The content server(s) 108 may store data associated with each user's 102 acquisition history in an e-commerce database 218. The data stored in the e-commerce database 218 may then be analyzed by the predictive models to determine which games 202 may also be of interest to the user 102.

As a result, the content server(s) 108 may monitor and track any user activity and/or interaction associated with the games 202 that are provided or made accessible by the content server(s) 108. Data representing such user activity may then be analyzed and/or processed utilizing the one or more predictive model in order to determine which games 202 are likely to be of greater interest to users 102.

### Pricing of Games

As stated above with respect to FIG. 2, the games 202 may be acquired 210 by the user 102, such as by the user 102 purchasing, renting, leasing, etc., the games 202. In various embodiments, a pricing module 220 may price the games 202 that are available to the users 102 may be differently based at least in part on the specific user 102 that is viewing those games 202. In other words, the pricing associated with the one or more games 202 that are being presented to a particular user may be customized based at least in part on one or more factors associated with that particular user 102. In various embodiments, the pricing module 220 may store information associated with each user 102 (e.g., subscription status, prior activity, purchase history, etc.) and use such information to price the games 202 appropriately, such as by presenting varying prices for the games 202 to different users 102.

In some embodiments, the pricing corresponding to different games 202 for a particular user 102 may depend upon whether that user 102 is a subscriber. In these embodiments, the user 102 may subscribe to an entity that provides and/or presents the games 202 or to a gaming service associated with the games 202. For instance, the system 200 may provide discounts to users 102 that have a subscription to the gaming service. As an illustrative example, provided that the price for a particular game 202 is $15.00 for non-subscribers, the system 200 may allow a user 102 that is a subscriber to acquire the same game 202 for $10.00. As a result, as a benefit of being a subscriber, subscriber users 102 may acquire games 202 at a discounted rate. A tiered pricing model may also be utilized to provide different prices for a particular game 202 to different users 102. For instance, for a particular game 202, the system 200 may offer a lowest price to preferred subscribers, a higher price to general subscribers, and a highest price to non-subscribers. However, although three pricing tiers are illustrated above, any number of tiers may be utilized.

In example embodiments, the system 200 may provide customized prices to users 202 once it is determined that a particular user 102 is accessing the system 200. More particularly, the system 200 may recognize different users 102 based at least in part on a master ID or login information associated with those users 102. Further, the system 200 may identify users 102 based on other identifying information submitted by the users 102 and/or an IP address associated with user devices 104 being utilized by the users 102. For instance, the system 200 may generally present default rates for the one or more games 202 that are being presented to users 102. However, once it is determined that a subscriber and/or a preferred user 102 is logged in, the pricing of those games 202 may be dynamically and/or automatically adjusted based on that particular user 102. Therefore, the pricing associated with various games 202 may be dynamically presented and/or adjusted based at least in part on the specific users(s) 102 in which those games 202 are being presented.

In other embodiments, variable and/or adjustable pricing for different users 102 may be based on any other factor in addition to whether users 102 are subscribers. For instance, pricing for games 202 may depend on prior activity associated with a user 202. For instance, such prior activity may include the identity, type, and/or number of games 202 that have previously been viewed, tried, played, downloaded, installed, and/or played by that particular user 202. Moreover, the prior activity may include the amount of time spent accessing the games 202, either as a whole or individually for each game 202, the frequency of interaction with the games 202, and/or the type of user device 104 being used to access the games 202. The pricing of games 202 for a particular user 102 may also be adjusted based on the total dollar amount a particular user 102 has spent trying, playing, downloading, and/or acquiring the games 202. As a result, the system 200 may offer discounted rates for games 202 to users 102 that have had a greater amount of user interaction with the games 202, an application or site associated with the games 202, and/or an entity or gaming service that provides access to the games 202. Therefore, users 102 may receive a reward (e.g., discounted game rates, etc.) for repeated and/or consistent use of the system 200 to access the games 202 and may be incentivized to use the system 200 in the future.

Furthermore, the discounted rates being offered to particular users 102 may be valid and/or available for a limited amount of time (e.g., 24 hours). That is, provided that a discounted rate for one or more games 202 is provided to a particular user 102, that user 102 may acquire that game 202 at the discounted rate provided that the game 202 is acquired before the limited time expires. In other embodiments, the discounted rates for one or more games 202 may not be limited in time and, therefore, may remain available. In further embodiments, or the discounted rates may remain available until it is determined that the user 102 is no longer a subscriber or until the user's 102 interaction with the games 202 falls below a certain threshold.

In example embodiments, the users 102 that access the games 202 may be located in various geographic locations across the world. As a result, the types of languages and currencies utilized by any two users 202 may differ. Accordingly, the system 200 may dynamically adjust which languages (e.g., English, Spanish, Japanese, etc.) and/or types of currency (U.S. Dollars, European Euros, Japanese Yen, etc.) are presented to the users 202 based at least in part on each user's 102 current geographic location. Additionally, the language and/or type of currency being presented to each user 102 may be based on a geographic location associated with a user device 104 being used to access the games 202, such as a geographic location in which the user device 104 is registered. Therefore, assuming that each user 102 visits a site to access the games 202, the games 202 may be dynamically and automatically presented in a language and/or type of currency that is customized to each user 102.

As stated above, the system 200 may detect a current geographic location associated with where a particular user 102 is accessing the games 202. For example, the system 200 may utilize any type of location detection technology (e.g., GPS, etc.) to determine where the user 102 and the corresponding user device 104 is actually located. Based at least in part on that location (e.g., Japan), the games 202 may be presented to that user 102 in a language that corresponds with that location (e.g., Japanese). For instance, text that identifies and/or describes the games 202 and/or the game itself may be presented to the user 102 in that particular language. In addition, if the system 200 provides prices for acquiring the games 202, the prices of the games 202 may be in the type of currency (e.g., Japanese Yen) associated with that geographic location (e.g., Japan). In some embodiments, once the current geographic location of the user 102 is determined, the appropriate language and/or currency may be automatically and/or dynamically updated and presented to the user 102.

Alternatively, the language and/or type of currency that is presented to the user 102 in conjunction with the games 202 may be based on the user device 104 that is being used to access the games 202 and/or information associated with the user 102 of the user device 104. For example, the language and/or currency that is most relevant to the user device 104 may be determined by detecting an Internet Protocol (IP) address of the user device 104 and/or any other information that specifies where the user device 104 is registered or is most commonly used. Further, if the user 102 has provided information that specifically identifies the user 102 (e.g., a master ID, login information, etc.), that information may be used to determine which language and/or currency should be presented to that user 102. As a result, if a particular user 102 lives and works in Japan, but is currently traveling within the United States, the system 200 may still present the games 202 in a language (e.g., Japanese) and currency (e.g., Japanese Yen) associated with the country of Japan.

Accordingly, since the language and/or type of currency may be automatically and/or dynamically customized for each user 102 that accesses the games 202, a single site may be used to present games to the users 102, regardless of where the users 102 are from and/or where the users 102 are currently located. Therefore, the system 200 may avoid having a separate site devoted to each different country, language, type of currency, etc. Having a single site that may be used by users 102 of different nationalities and ethnicities may reduce or even eliminate the cost of hosting, operating, and maintaining multiple different sites.

### Batch Processing Module

FIG. 3 illustrates a diagram showing various components and/or modules of the content server(s) 108. In some embodiments, FIG. 3 may illustrate modules associated with the batch processing module 122 of the content server(s) 108. As mentioned previously, the content server(s) 108 may be any type of server, a service provider, and/or a service that provides and/or facilitates providing one or more games 202 to consumers. Moreover, the content sever(s) 108 may include the batch processing module 122, as shown in FIG. 1, which may also include a realtime database module 302, a processing database module 304, an analytics module 306, an aggregation module 308, and one or more predictive models 310. As stated previously, the content server(s) 108 may track user activity associated with the one or more games 202, store data representative of such user activity, process the data to generate one or more predictive models 310, and/or utilize the predictive models 310 to determine which games are likely to be of interest to users 102.

In various embodiments, the realtime database module 302 may be a relational database management system that may provide access to a number of different databases. In some embodiments, the realtime database module 302 may be a MySQL relational database and/or may be a production environment or a realtime database that includes multiple sources of data, such as the processing database 212, the download database 216, the e-commerce database 218, a game catalog database, etc. Moreover, the realtime database module 302 may store data that can be used to build a profile for each user 102. That is, each time a particular user 102 interacts with the content server(s) 108, such as by interacting with a site (e.g., a website) and/or a application utilizing the user device 104, the batch processing module 122 may store this data in the realtime database module 302. Likewise, any user interaction with the one or more games 202 (e.g., by viewing, trying, playing, installing, downloading, and/or acquiring the games 202) may be represented by data that is stored in the realtime database module 302.

Therefore, for each user 102, the realtime database module 302 may store data associated with each user 102, such as user behavior with respect to the content server(s) 108, sites associated with the content server(s) 108, applications downloaded to the user device 104, and/or the one or more games 202. For instance, the processing database 212 may be included within the realtime database module 302 and may store data indicating the extent to which users 102 installed, played 204, and/or viewed 206 the one or more games 206. Further, the download database 216 of the realtime database module 302 may include data that may represent user download history of the one or more games 202. For instance, this data may reflect whether the user 102 tried 208 any of the one or more games 202 by actuating a “try button,” for example. The realtime database module 302 may also include the e-commerce database 218, which may store data representing user acquisition (e.g., purchase, rent, lease, etc.) 210 of the one or more games 202. By maintaining such historical data, trends relating to user behavior associated with the users 102 and/or the one or more games 202 may be identified.

In other embodiments, the realtime database module 302 may include a game catalog database that may store the games 202 that may be provided to and/or accessed by users 102. Additionally, the realtime database module 302 may include data indicating what applications have been installed on the user device 104 and the user's 102 use of those applications (e.g., tracking sessions and time associated with the applications, etc.). Browser information (e.g., browser history) and/or cookies data may also be collected and stored by the realtime database module 302. The realtime database module 302 may also collect and/or store any data provided by the user 102, such as data that was voluntarily provided by the user 102 and/or data that was requested from the user 102. Further, the data stored by the realtime database module 302 may also include any message click data. For example, if e-mail messages and/or SMS messages are transmitted to the user 102, the realtime database module 302 may store any data that represents user actuation of any links or other content included in such messages. The realtime database module 302 may also monitor whether the user 102 opened and/or replied to such messages. Optionally, the realtime database module 302 may also include any data provided by third party game providers.

In various embodiments, the data stored by the realtime database module 302 may be transmitted to and/or fed into the processing database module 304. The processing database module 304 may be a parallel processing data warehouse engine and may perform functions such as data warehousing and/or predictive analysis. That is, the processing database module 304 may be a database used for data reporting and analysis and/or used for utilizing existing data to make predictions about future events. Furthermore, the processing database module 304 may be a hardware unit or a software unit, or a combination thereof. In some embodiments, once the data stored in the realtime database module 302 is transmitted to the processing database module 304, the data may be aggregated and provided to the analytics module 306.

The analytics module 306 may determine correlations between the data provided by the processing database module 304 and may take the form of analytical software. Moreover, the analytics module 306 may include or generate one or more predictive models 310 for making predictions based at least in part on the data provided by the processing database module 304. Moreover, the correlations and predictive data generated by the analytics module 306 may be determined using one or more algorithms, which will be discussed in additional detail below. In various embodiments, the predictive models 310 may be generated by the batch processing module 122 or the predictive model module 124.

That is, based at least in part on data indicating user behavior, and potentially other data, the analytics module 306 may determine which games 202 are more likely to be of interest to different users 102. For instance, the analytics module 306 may determine that, based on characteristics associated with a first game 202 that the user 102 viewed, tried, played, installed, downloaded, and/or acquired, the user 102 may be interested in a second, different game 202. The analytics module 306 may output the predictive data in any manner, such as by outputting the raw data, outputting correlations or relationships within a set of data, and/or outputting tables or lists that indicate correlations or relationships between the data. In some embodiments, the tables may indicate correlations between two or more variables (e.g., users 102, master IDs, games, game IDs, genres of games 202, genre IDs, etc.).

As stated above, the output from the analytics module 306 may include one or more tables that represent correlations between two or more games 202. For instance, the table(s) may include correlations between different game 202 pairs (e.g., a first game and a second, different game 202). In the table(s), the games 202 may be ordered based on the degree of correlation between the games 202, meaning that games that have the highest correlations may be presented first, or vice versa. In addition to being configured to output a table that includes a degree of correlation between each game 202, tables may also be generated for each of the games 202 that are associated with the content server(s) 108. Accordingly, with respect to a particular game 202, the batch processing module 122 may determine varying degrees of correlation between that particular game 202 and any other game 202. That is, for a first game 202, the analytics module 306 may determine that a second game 202 has a higher correlation to the first game 202 than a third game 202.

Using the tables described above, if it is determined that the user 102 has viewed, tried, played, installed, acquired, and/or downloaded a particular game 202, the analytics module 306 may utilize the correlation table associated with that particular game 202 to determine which other games 202 are most likely to be of interest to the user 102. In these embodiments, the games 202 that have the highest correlation to that particular game 202 may then be recommended to the user 102. In other embodiments, a list that includes the highest correlated games 202 may be created. Since the user 102 may not want to access games 202 in which the user 102 has already viewed, tried, played, installed, acquired, and/or downloaded, and instead may desire to play different games 102, the list may be filtered so that those games 202 that have been previously accessed by the user 102 are removed from the list. From the filtered list, the games 202 that are determined to have the highest correlations may be provided to the user 102. As a result, the content server(s) 108 may attempt to ensure that new or different games 202 are being introduced to the user 102.

In other embodiments, correlations may be determined between users 102 and the one or more games 202. For instance, the analytics module 306 may determine correlations between master IDs associated with various users 102 and specific games 202. Therefore, the games 202 that are most likely relevant to each user 202 may be determined and represented in such a table. Additionally, the analytics module 306 may determine correlations between master IDs corresponding to different users 102 and genres or categories of games 202, which, for example, may include hidden object, time management, and/or any other genre of games 202. With respect to genres of games 202, the analytics module may determine attributes associated with games 202 the user 102 has previously viewed, tried, played, installed, acquired, and/or downloaded and then identify genres of games 202 that share at least one or more of those attributes. That is, the analytics module 306 may map master IDs to different attributes in order to determine which genres of games 202 would likely be of greater interest to the users 102.

Based on this mapping, the analytics module 306 may generate a table that illustrates correlations between users 102 and different genres of games 202. For each user 102, which may be represented by a master ID, the table may include some indication that the user 102 may be more or less likely to be interested in each particular genre. For example, for each genre included in the table, the table may state a predicted level of interest in those genres, such as by utilizing numbers (e.g., a scale of 0 to 1) and/or characters (e.g., High, Medium, or Low interest). As a result, the table may represent correlations between each user 102 and different genres of games. If it is determined that a particular user 102 is likely to be interested in a certain genre (e.g., hidden object games), games 202 that fall within that genre may be recommended and/or provided to that user 102. For instance, the content server(s) 108 may determine the last purchased or downloaded game 202 for a particular user 102 and then, based on one of the correlation tables, recommend one or more games 202 and/or genres of games 202 that are most likely to be of interest to that user 102.

In additional embodiments, the data (e.g., correlation data, tables, etc.) generated by the analytics module 306 may be output to the aggregation module 308. Moreover, the data output by the analytics module 306 may also be combined with data output from the processing database module 304 (e.g., user behavior data, etc.) and then provided to the aggregation module 308. In other embodiments, the analyzed and aggregated data (e.g., data files 214) may then be stored in the realtime database module 302 and/or provided to the realtime delivery module 126.

As mentioned previously, one or more predictive models 310 and/or algorithms may be utilized by the analytics module 306 to determine correlations between at least two different games 202. In some embodiments, the correlation may be determined utilizing Equation 1, as shown below:

$${γ}_{xy} = \frac{{\sum }_{i = 1}^{n} ( {x}_{i} - \overline{⋁} ) ( {y}_{i} - \overline{⋁} )}{( n - 1 ) {S}_{x} {S}_{y}} \qquad ( 1 )$$

In Equation 1, γ_{xy} may correspond to the measure of correlation between a first game (x) and a second game (y), which also may be referred to as a correlation coefficient or the Pearson's correlation coefficient. Moreover, xᵢ and yᵢ, may correspond to a standard score for games x and y, respectively. In some embodiments, v̅ may correspond to a sample mean score, n may refer to the number of games 202, Sₓ may refer to the standard deviation with respect to game x, and S_{y} may refer to the standard deviation with respect to game y. That is, Equation 1 may provide a correlation coefficient with respect to games x and y as the means of the products of the standard scores based at least in part on a sample of paired data (games x and y). In some embodiments, once the correlation coefficient has been determined for two different games 202, this correlation value may be compared to the correlation coefficient for a different pair of games 202.

In other embodiments, the analytics module 306 may utilize logistic regression analysis to determine which games 202 and/or genres of games 202 are most likely to be of interest to different users 102. That is, based at least in part on user data available to the analytics module 306 (e.g., user behavior data, past game acquisitions, game play history, etc.), one or more predictive models 310 may be used to predict the probability that a particular user 102 would be interested in viewing, trying, playing, installing, downloading, and/or acquiring certain games 202. For instance, the analytics module 306 may utilize Equation 2 and Equation 3, as shown below:

$$\begin{matrix}z = {B}_{0} + {B}_{1} {x}_{1} + {B}_{2} {x}_{2} + … {B}_{n} {x}_{n} & ( 2 ) \\ f ( z ) = \frac{{e}^{≡}}{{e}^{≡} + 1} & ( 3 )\end{matrix}$$

In some embodiments, z may represent a variable that may be utilized to determine whether a particular user 102 is likely to be interested in a game 202 or a particular genre of games 202, which may be represented by f(z). Moreover, B₀ may represent an intercept, which may represent the value of z when the value of the independent variables (e.g., B₁x₁, B₂x₂, etc.) is zero. Furthermore, B₁, B₂, and Bₙ may be various weighting coefficients and x₁, x₂, and xₙ may represent different games 202 or different genres of games 202. In various embodiments, B₁x₁, B₂x₂, and Bₙxₙ may be utilized to determine whether a particular user 102 is likely to have a High, Medium, or Low interest in a particular game 202 or a certain genre of games 202.

In other embodiments, cosine similarity may be utilized to determine which games 202 and/or genres of games 202 are likely to be of interest to users 102. That is, the similarity between two vectors may be measured by measuring the cosine of the angle between the two vectors. In example embodiments, a smaller angle between the two vectors may represent a closer correlation between users 102, games 202, and/or genres of games 202.

### Realtime Delivery Module

FIG. 4 illustrates a diagram representing a system 400 for analyzing, processing, recommending, and/or delivering one or more games and/or genres of games that are to be provided to consumers. In various embodiments, FIG. 4 includes the data files 214, and the realtime delivery module 126, which may include a production server 402, a memory cache module 404, and a PHP (hypertext preprocessor) module 406. As shown, the production server 402, the memory cache module 404, and the PHP layer module 406 may be included within the realtime delivery module 126.

As stated above with respect to FIG. 3, the aggregation module 308 of the batch processing module 122 may output the data files 214 to the realtime delivery module 126. The data files 214 may include a variety of data that may represent correlations between users 102, games 202, genres of games 202, etc. Moreover, the data files 214 may include lists, tables, and/or any other format that indicate a relative strength of such correlations. For instance, in some embodiments, the data files 214 may include lists or tables that represent correlations between users 102 and games 202. That is, the data files 214 may indicate correlations between master IDs associated with one or more users 102 to various games 202, which may indicate the likelihood that users 102 would be interested in different games 202.

In other embodiments, the data files 214 may include lists or tables that represent correlations between a game 202, which may be shown by an identifier associated with that game 202 (e.g., game ID), and other games 202. That is, for a particular game 202 that was viewed, tried, played, installed, downloaded, and/or acquired by a particular user 102, the data files 214 may identify different games 202 that may likely to be of interest to that user 102. This may be due to similarity of the games 202, whether the games 202 belong to the same of different genres, the price of the games 202, and/or any other characteristic of the games 202 that may determine whether a game 202 is more or less likely to be relevant to that user 102.

Additionally, the data files 214 may include correlations between different genres of games 202 and different games 202, with each genre possibly being represented by a genre ID. For instance, lists or tables may indicate the degree of correlation, if any, between one or more games 202 and different genres of games 202 (e.g., hidden object, time management, warfare, etc.). As a result, if it is determined that a particular user 102 is interested in a certain genre of games 202 and/or games 202 that are included within a particular genre of games 202, it could then be determined that the user 102 may likely be more interested in games 202 that have a higher correlation with that genre.

In further embodiments, the data files 214 may also include correlations between first time customers and games 202. For instance, the content server(s) 108 may track and collect data regarding the games 202 and/or genres of games 202 that users 102 first viewed, tried, played, installed, downloaded, and/or acquired. The content server(s) 108 may also determine which games 202 those users 102 subsequently viewed, tried, played, installed, downloaded, and/or acquired. As a result, when it is determined that a first-time user 102 played or otherwise interacted with a certain game 202, the content server(s) 108 may then use the foregoing data to determine which games 202 the user 102 would likely play or would be interested in next. The batch processing module 122 may continuously track the activity of first time users 102 such that a lists or tables relating to correlations between first time users 102 and games 202 may be current. As mentioned previously, the data files 214 may include correlations between any type of information (e.g., users 102, games 202, genres, etc.) and may be output to the realtime delivery module 126, as shown in FIG. 4.

In particular, the data files 214 may be provided to the production server 402 of the realtime discovery module 124. The production server 402 may store and/or process the data files 214 such that games 202 may be subsequently presented and/or recommended to the users 102. Data may then be transmitted from the production server 402 to the memory cache module 404. In some embodiments, the memory cache module 402 may be a memory-based storage engine and/or a data store. Moreover, the memory cache module 404 may be network-accessible and may serve as a persistent database. The memory cache module 402 may also sort and/or organize the correlated data such that games 202 may be provided to users 102 rapidly and efficiently.

Once the data is provided to the memory cache module 404, clients (e.g., servers, other entities, etc.) may call the PHP layer module 406 for the data. In various embodiments, the PHP layer module 406 may be a REST (Representational State Transfer) service, meaning that the users 102 may initiate requests to the content server(s) 108. For instance, the users 102 may request games 202 from the content server(s) 108, such as by requesting to view, try, play, download, install, and/or acquire the games 202. Subsequently, the content server(s) 108 may process the request and return an appropriate response, such as obtaining the requested games 202 from the memory cached module 406 and providing the games 202 to the user 102 that submitted the request.

In some embodiments, the content server(s) 108 may provide a recommended game 202 and/or genre of games 202 to a particular user 102. As stated above, the recommendation may be based on a profile of the user 102, prior actions associated with that user 102 (e.g., viewing, paying, downloading, etc., games), and/or any other information. In particular, the content server(s) 108 may utilize lists and/or tables that include correlations between the users 102, games 202, genres of games 202, etc. For instance, the content server(s) 108 may first determine whether a master ID associated with the user 102 is known. If so, the content server(s) 108 may identify games 202 that have a relatively high correlation to that particular master ID and then recommend those games 202 the user 102. Otherwise, the content server(s) 108 may determine games 202 that the user has previously viewed, tried, played, installed, downloaded, and/or acquired. If the content server(s) 108 are able to determine a game ID associated with those games 202, the content server(s) 108 may identify games 202 that are correlated to that game ID and provide/recommend those games 202 to the user 102.

Furthermore, if the game ID is also unknown, the content server(s) 108 may determine whether a genre ID associated with games that the user 102 has viewed, tried, played, installed, downloaded, and/or acquired is available. Provided that the genre ID is determined, the content server(s) 108 may recommend games to the user 102 that are within that specific genre of games 202. However, if the genre ID is not known, the content server(s) 108 may resort to a first time customer game list in order to recommend games 202 to the user 102.

Regardless of how games 202 that are to be recommended to the user 102 are identified, the realtime delivery module 126 may identify one or more games 202 that may likely be of interest to the user 102. The realtime delivery module 126 may then return a single game 202, multiple games 202, a list of games 202, and/or multiple lists of games 202 to the IM clients module 128. In some embodiments, the IM clients module 128 may then provide the games 202 to different users 102.

### IM Clients Module

FIG. 5 illustrates a diagram representing a system 500 for providing and/or recommending one or more games to users. As shown, the system 500 includes the intelligent merchandising (IM) clients module 128, which may include a game application 502, a site 504, customer service 506, messages 508, and mobile application 510. In some embodiments, the IM clients module 128 may be included within the content server(s) 108 and may be interchangeably referred to as a communication module or a recommendation module. Further, since the user 102 may access the games 202 in multiple different ways, the content server(s) 108 may therefore provide recommended games to the user 102 utilizing different channels.

In some embodiments, in order for the games 202 to be provided and/or recommended to users 102, the correlation associated with those games 202 may have to meet or exceed a predetermined threshold. That is, the IM clients module 128 may determine whether a correlation score associated with a particular game 202 meets or exceeds a particular threshold and, if so, that game 202 may be provided to the user 102. Otherwise, a different game 202 may be provided to the user 102. In other embodiments, the one or more games 202 having the highest correlations to prior user activity and/or any other data may be provided to users 102. In order to determine which games 202 have higher correlations, each game 202 may be assigned a correlation score or some type of weight. As a result, the IM clients module 128 may attempt to ensure that the games 202 that are most likely to be of interest to users 102 are actually provided and/or recommended to the users 102.

For instance, the IM clients module 128 of the content server(s) 108 may provide games 202 and game recommendations via the game application 502. In some embodiments, the game application 502 may be downloaded to and/or installed locally on the user device 104. Utilizing the game application 502, the user 102 may view, try, play, install, download, and/or acquire one or more games 202. While the user 102 interacts with the game application 502, the content server(s) 108 may monitor any action taken by the user 102. In various embodiments, the IM clients module 128 may recommend and/or promote one or more games to the user 102 in any manner. For example, the user interface or display of the user device 104 might contain a recommendations module that dynamically presents different games 202 to the user 102. Moreover, the particular games 202 that are promoted to the user 102 may change in real-time, or in near real-time, based at least in part on the most recent actions taken by the user 102. That is, the game(s) 202 that are currently being promoted to the user 102 may reflect prior actions taken by that user 102 (e.g., games played, games viewed, etc.). However, if the user 102 plays a different game 202, the game(s) 202 being presented to the user 102 may dynamically change based on the game most recently played. Therefore, the games 202 that are promoted to the user 102 may be tailored to the user's 102 current preferences and most recent actions.

In other embodiments, the games 202 being promoted to the user 102 may be tied to a user profile of the user 102. That is, since a user profile may reflect games 202 that were played, downloaded, acquired, etc., the games 202 that are recommended to the user 102 may be based on such games 202. As a result, the games 202 that are recommended may have a higher likelihood of being of interest to the user 102. Moreover, the user profile may be periodically updated (e.g., every 24 hours) and the recommendations may be based on the most current update to the user profile. In these embodiments, the recommendations may not be provided in real-time since the user's 102 prior selection of certain games 202 may not reflect user interest in those games 202. For instance, the user 202 may have tried and disliked a particular game 202. As a result, the IM clients module 128 may promote games 202 to the user 102 based at least in part on user interaction with games 202 that meets or exceeds a predetermined threshold. For instance, the previously accessed games 202 may have to be played for a specified duration, downloaded, and/or acquired in order for the content server(s) 108 to use this data for the purpose of recommending other games 202.

Furthermore, prior to recommending and/or promoting games 202 to the user 102, the game(s) 202 that are recommended to the user 102 may first be filtered. For example, the one or more games 202 recommended to the user 102 may be dynamically filtered to exclude games 202 that have already been viewed, tried, played, installed, downloaded, and/or acquired by the user 102. That way, the user 102 may consistently be introduced to new and/or different games 202. Additionally, the recommended games 202 may be viewable via a separate page or tab via the game application and/or the recommendations may be viewable on each page of the display, such as being shown persistently regardless of whether the user 102 scrolls in any direction. In example embodiments, the recommendations may include text, graphics, video, and/or other animation promoting the game 202.

In other embodiments, games 202 may be recommended to users 102 via the site 504, such as a website associated with the entity that provides and/or provides access to the games 202. When the user 102 accesses the site 504 for any purpose, the IM clients module 128 may recommend games 202 to the user 102 in a manner similar to how games 202 are presented to users 102 via the game application 502. For instance, the games 202 that are recommended to users 102 may be based at least in part on the user's profile, prior actions taken by the user 102, and/or correlations determined by the content server(s) 108, as discussed above. Furthermore, the recommended games may be provided to the user 102 via a particular portion of the site 504, via a pop-up window, persistently on the site 504, and/or via any other manner of providing the recommended games 202 to the user 102. In some embodiments, the user 102 may access a website or a game application to play the one or more games 202. Upon the content server(s) 108 identifying that particular user 102, such as by the user 102 entering identifying information or by the content server(s) 108 recognizing the device 104 being used to access the website, the content server(s) 108 may provide personalized game recommendations to that user 102. Moreover, based at least in part on subsequent user interaction with the games 202, the content server(s) 108 may recommend different games 202 that are more similar to the games 202 that the user 102 most recently accessed.

Moreover, games 202 may be recommended to the user via forms of customer service 506. In some embodiments, games 202 may be promoted to the user 102 via a customer service 506 page associated with the game application 502 and/or the site 504. The games 202 may also be provided via the telephone, such as when a user 102 inquires about games 202 that they should play or purchase. Further, games 202 may be recommended to users 102 via one or more messages 508, such as, for example, e-mail messages, SMS messages, and/or instant/chat messages. More particularly, the IM clients module 128 may transmit e-mail messages and/or SMS messages notifying the user 102 of games 202 that are available (e.g., new games, games not accessed by the users 102, etc.). Further, the games 202 may either be proactively provided to the user 102 or be in response to a user request. In some embodiments, the games 202 that are provided may be the same for all users 102 or may be personalized for at least one or more of the users 102.

In further embodiments, games 202 may be provided to users 102 via the mobile application 510 that may be downloaded to, and/or is accessible using, the user device 104. The mobile application 510 may be the same as or similar to the game application 504 and may allow the user 102 to stream games 202 from the content server(s) 108 to the user device 104 in real-time. Before, after, or during the games 202 are streamed to the user 102, the IM clients module 128 and/or the mobile application 510 may recommend one or more games 202 to the user 102. Furthermore, games 202 may be recommended to users 102 in any other manner that permits the users 102 to become aware of new and/or different games 202. As a result, based at least in part on prior user activity, information provided by users 102, and/or information included in a user profile, games 202 that are promoted and/or recommended to different users 102 are more likely to be of interest to those particular users 102.

### Game Presentation User Interface

FIG. 6 illustrates a diagram representing a system 600 for providing and/or recommending one or more games to users. More particularly, the system 600 may include a user device 104, which may include a display 114. In some embodiments, the display 114 may include a game interaction portion 602 and a game recommendation portion 604. The game interaction portion 602 and the game recommendation portion 604 may present one or more games 606-610 to a user (e.g., user 102). In various embodiments, the user 102 may access the games 606-610 via an application that may be downloaded to and/or stored on the user device 104. In other embodiments, the user 102 may operate the user device 104 to access the games 606-610 via a site (e.g., a website) that provides (or provides access to) the games 606-610. Moreover, the application associated with the user device 104 and/or the site may allow the user 102 to view, try, play, download, install, and/or acquire the games 606-610. For the purposes of this discussion, the term “portion” may be interchangeably referred to a “window” or a “section.”

As shown, the user device 104 may include the display 114, which may present the games 606-610 via the application associated with the user device 104 and/or a site that provides (or provides access to) the games 606-610. Moreover, the game interaction portion 602 of the display 114 may represent any user interface that enables the user 102 to view, try, play, download, install, and/or acquire the games 606-610. Moreover, the game recommendation portion 604 may include recommendations and/or promotions for one or more games 606-610 that are directed to the user 102. Although the game recommendation portion 604 is shown to be adjacent (e.g., below) to the game interaction portion 602, the game recommendation portion 604 may be situated in any location on the display 114. For instance, the game recommendation portion 604 may be above or to the side of the game interaction portion 602, may be overlaid over the game interaction portion 602, and/or may occlude, or be occluded by, the game interaction portion 602. Moreover, the game recommendation portion 604 may comprise a separate page of the display and/or may be represented by one or more tabs.

In various embodiments, the user 102 may interact with one or more games (e.g., game 606) via the game interaction portion 602 of the display 114. For example, the user 102 may view, try, play, download, install, and/or acquire (e.g., purchase, lease, rent, etc.) game 606. Moreover, based at least in part on the games that the user 102 has previously interacted with, the system 600 may recommend and/or promote one or more games that are more likely to be of interest to the user 102. More particularly, since game 606 is included in the game interaction portion 602 of the display 114, the user 102 may have previously selected game 606 to view, try, play, download, install, and/or acquire. Based at least in part on this selection, based on other games that the user has viewed, tried, played, downloaded, installed, and/or acquired, and/or based on information included in a user profile associated with the user 102, the system 600 may dynamically and/or automatically recommend one or more games (e.g., game 608) that are determined to be of interest to the user 102. For example, game 606 may be recommended in the game recommendation portion 604 of the display 114 since it may share characteristics with games the user 102 has previously accessed.

In some embodiments, the recommended games (e.g., game 606) may be updated in the game recommendation portion 604 in real-time. Alternatively, games that are recommended (e.g., game 606) in the game recommendation portion 604 may be updated one or more times in a predetermined period of time (e.g., 24 hours). In these embodiments, the games may not be recommended in real-time since certain selections of games made by the user 102 may not necessarily reflect the user's 102 current interests. For instance, if the user 102 selected a game that the user disliked, the system 600 may not want to recommend similar games in real-time. Furthermore, when it is determined that one or more games should be recommended to the user 102, the system 600 may dynamically filter the games that may be recommended to the user 102 in order to exclude those games that have previously been viewed, tried, played, downloaded, installed, and/or acquired by the user 102. As a result, the games recommended in the game recommendation portion 604 may include games that have yet to be experienced by the user 102.

Furthermore, assume that the user 102 selected game 608 from the game recommendation portion 604, such as by expressing some indication to view, try, play, download, install, and/or acquire game 606. In some embodiments, the user 102 may make such an indication while the user 102 is interacting with game 606, or afterwards. As a result, since game 608 may have been selected, game 608 may appear in the game interaction portion 602 of the display 114. Further, based at least in part on the selection of game 608 and/or previous user interaction with other games, one or more additional games (e.g., game 610) may be recommended in the game recommendation portion 604 of the display. In some embodiments, the recommendation of game 610 may occur dynamically and/or automatically such that new games are continued to be promoted and/or recommended to the user 102. Furthermore, because the recommendations may be based on previous actions by the user 102 and/or information included in a user profile associated with the user 102, the recommended games may be more likely to be of interest to the user 102.

In example embodiments, the game recommendation portion 604 may be persistently presented on the display 114. For instance, regardless of whether the user 102 navigates to different pages or portions of the application and/or the site that is providing (or providing access to) the games, the game recommendation portion 604 may be continuously displayed to the user 102. That way, since the user 102 may have a continued opportunity to select the recommended games, there may be a higher likelihood that the user subsequently interacts with the recommended games.

Additionally, in response to the user 102 selecting a particular game 202, the predictive model(s) 310 and/or algorithms may identify one or more additional games 202 that may be presented to the user via the game recommendation portion 604 of the display 114. In some embodiments, the games 202 that are recommended to the user 102 may be offered at a discount for a limited amount of time. That is, not only may be recommended games 202 be customized to the user 102, but the recommended games 202 may also be available to that user 102 at a discounted rate.

### Example Processes

FIGS. 7 and 8 describe various example processes of providing recommendations for content based at least in part on prior user activity. The example processes are described in the context of the environment of FIGS. 1-6 but are not limited to those environments. The order in which the operations are described in each example method is not intended to be construed as a limitation, and any number of the described blocks can be combined in any order and/or in parallel to implement each method. Moreover, the blocks in FIGS. 7 and 8 may be operations that can be implemented in hardware, software, or a combination thereof. In the context of software, the blocks represent computer-executable instructions stored in one or more computer-readable storage media that, when executed by one or more processors, cause one or more processors to perform the recited operations. Generally, the computer-executable instructions may include routines, programs, objects, components, data structures, and the like that cause the particular functions to be performed or particular abstract data types to be implemented.

FIG. 7 is a flow diagram illustrating an example process of customizing rates for games based on an identity of one or more users. Moreover, the following actions described with respect to FIG. 7 may be performed by a server, a service provider, a merchant, and/or the content server(s) 108, as shown in FIGS. 1-6.

Block 702 illustrates presenting one or more games at default rates. In some embodiments, the systems and processes described herein may make one or more games available to a plurality of users (e.g., users 102) via respective user devices (e.g., user devices 104). Moreover, the one or more games may be acquired (e.g., purchased, rented, leased, etc.) at varying rates or prices that may accompany the games. In these embodiments, the rates that are provided to the users may be referred to as default rates, meaning that the rates may be the same for each user.

Block 704 illustrates detecting an identity of a user associated with a user device. More particularly, if it is determined that a user device is accessing and/or interacting with at least one of the one or more games, the identity of the user operating the user device may be determined. In some embodiments, the identity of the user may be determined by information associated with the user (e.g., master ID, user profile, etc.), information provided by the user (e.g., login information, etc.), and/or information associated with the user device.

Block 706 illustrates analyzing information associated with the user. In other embodiments, once the identity of the user has been determined, the systems and processes described herein may analyze information relating to the user. For instance, a subscription status of the user may be determined. More particularly, it may be determined whether the user is a subscriber to a provider, a service, and/or a site or application associated with the one or more games. Furthermore, prior user activity relating to the one or more games and any other information may also be identified. Such user activity may include a type of the user device operated by the user, an identity, a type and/or a number of games accessed by the user, an amount of time spent accessing the games, a frequency in which the user has accessed the games, a total amount spent to acquire the games (either as a whole or individually with respect to a game or a group of games), and/or an amount or quality of feedback provided by the user. The feedback may relate to feedback or comments provided by the user that relate to the substance of one or more games and/or a platform in which the games are being presented.

Block 708 illustrates offering customized rates for the one or more games to the user. In example embodiments, based at least in part on the identity of the user and/or the information associated with the user, the systems and processes described herein may dynamically adjust the default rates such that customized rates for the one or more games are offered to the user. That is, if it is determined that the user is a subscriber and/or if a degree of prior user interaction is sufficiently high (e.g., exceeds a predetermined threshold), discounted rates for the one or more games may be offered to that user.

Moreover, the customized rates may be provided to the user for a limited or predetermined amount of time. Accordingly, if the user does not acquire the games within this amount of time, the customized rates may no longer be available. For instance, the adjusted or customized rates for the games may be converted back to the default rates if it is determined that the user is no longer a subscriber and/or if it is determined that the degree of user interaction falls below the predetermined threshold.

FIG. 8 is a flow diagram illustrating an example process of presenting one or more games to users in a language and/or a type of currency that is relevant to the users. Moreover, the following actions described with respect to FIG. 8 may be performed by a server, a service provider, a merchant, and/or the content server(s) 108, as shown in FIGS. 1-6.

Block 802 illustrates presenting one or more games to a plurality of user devices. As stated above, one or more games may be available to users of user devices via a site, an application stored on the user device, etc. For example, users may utilize corresponding user devices to view, try, play, download, install, and/or acquire (e.g., purchase, lease, rent, etc.) the one or more games.

Block 804 illustrates detecting a geographic location associated with one of the user devices. In some embodiments, if it is determined that at least one user device has accessed and/or interacted with the one or more games, geographic location information associated with the user device may be determined. For instance, location information associated with user device may include an IP address or any other type of identifying information that indicates where the user device is registered, where the device is most commonly used, etc.

Block 806 illustrates detecting a current geographic location of the user device. Alternatively, or in addition to detecting a geographic location associated with the user device, a current geographic location of the user device may be determined. In some embodiments, the geographic location of where the user device is currently located may be determined utilizing any type of location-detecting technology (e.g., GPS) or any other techniques for determining the location of a device.

Block 808 illustrates customizing a language or a type of currency for the one or more games. In some embodiments, the geographic location information associated with the user device and/or the current geographic location of the user device may be utilized to customize the presentation of the games to the user. For example, the systems and processes described herein may present the games in a language that is most commonly used in the geographic location and/or the current geographic location. That is, the site or application in which the games are presented, the games, and/or descriptions of the games may be presented in a language that the user is more likely to understand. For instance, if the determined location was the country of Japan, the games may be presented to the user in the Japanese language so that the user (who is presumably Japanese) may more efficiently interact with the games.

In addition, the determined geographic location information and/or the current geographic location may be utilized to customize a type of currency associated with the games. Using the foregoing example, since it is determined that the user device is likely to be in Japan, the rates (e.g., prices) of the games that are presented to the user may be customized to the currency of Japan (e.g., Japanese Yen). The rates may be included with the games to inform the user how much it will cost to acquire such games. Therefore, having the rates be in a type of currency that is customized to the user may allow the user to better understand the actual cost associated with acquiring the games. Furthermore, because the language and/or type of currency relating to the games may be customized for each user, the games may be presented utilizing a single site (e.g., website), as opposed to having multiple different sites for each country, language, type of currency, etc.

Accordingly, the systems and/or processes described herein may monitor actions taken by consumers and utilize such data to generate predictive models and/or algorithms. Based on historical data representing consumers most recent interests in media content (e.g., games), the predictive models may predict and identify media content that is more likely to be of interest to those consumers. Then, that media content may be recommended and/or promoted to consumers through different communication channels. As a result, the systems and/or processes described herein may provide content to consumers that has a higher likelihood of having attributes and/or characteristics that are consistent with each consumer's interests.

### CONCLUSION

Although the subject matter has been described in language specific to structural features and/or methodological acts, it is to be understood that the subject matter defined in the appended claims is not necessarily limited to the specific features or acts described. Rather, the specific features and acts are disclosed as illustrative forms of implementing the claims.

What is claimed is:

1. A method comprising:
in response to a user device accessing at least one of a plurality of games, detecting a current geographic location of the user device or geographic location information associated with the user device;
customizing a language associated with the at least one game and a type of currency of a rate associated with the at least one game based at least in part on the current geographic location or the geographic location information;
determining an identity of a user that is associated with the user device; and
dynamically adjusting the rate associated with the at least one game based at least in part on the identity of the user.

2. The method as recited in claim 1, wherein dynamically adjusting the rate is based at least in part on a subscription status of the user.

3. The method as recited in claim 1, wherein dynamically adjusting the rate is based at least in part on a degree of interaction between the user and the plurality of games.

4. The method as recited in claim 3, wherein the degree of user interaction is based at least in part on a type of the user device, an identity, a type or a number of the plurality of games accessed by the user, an amount of time spent accessing the plurality of games, a frequency in which the user accessed the plurality of games, a cost acquire the plurality of games, or feedback provided by the user.

5. The method as recited in claim 1, wherein the rate associated with the at least one game corresponds to a price or cost to acquire the at least one game.

6. The method as recited in claim 1, wherein the user is identified based at least in part on identification information provided by the user or identifying information associated with the user device.

7. The method as recited in claim 1, further comprising providing the adjusted rate to the user for a limited amount of time.

8. The method as recited in claim 1, further comprising converting the adjusted rate to a default rate when it is determined that the user is no longer a subscriber or when a degree of user interaction falls below a predetermined threshold.

9. The method as recited in claim 1, wherein:
the language and the type of currency are used in the current geographic location and the geographic location information; and
the language is customized for the at least one game and a description associated with the at least one game.

10. The method as recited in claim 1, wherein customizing the language and the rate associated with the at least one game allows the plurality of games to be provided on a single site.

11. One or more computer-readable media having computer-executable instructions that, when executed by one or more processors, perform operations comprising:
providing one or more content items at default rates that are accessible by a plurality of user devices;
detecting an identity of a user associated with one of the plurality of user devices that is determined to have accessed at least one of the one or more content items; and
dynamically adjusting the default rates of the one or more content items to customized rates based at least in part on the identity of the user.

12. The one or more computer-readable media as recited in claim 11, wherein the operations further comprise dynamically adjusting the default rates of the one or more content items such that the customized rates reflect discounted rates.

13. The one or more computer-readable media as recited in claim 11, wherein the operations further comprise dynamically adjusting the default rates based at least in part on whether the user is a subscriber to a provider or a service associated with the one or more content items.

14. The one or more computer-readable media as recited in claim 11, wherein the operations further comprise dynamically adjusting the default rates based at least in part on a degree of user interaction with the one or more content items.

15. The one or more computer-readable media as recited in claim 11, wherein:
the one or more content items are games; and
the operations further comprise providing the customized rates for the games for a limited amount of time.

16. A method comprising:
presenting one or more content items that are accessible by a plurality of user devices;
detecting a geographic location associated with a user device that is determined to have accessed at least one of the one or more content items; and
dynamically customizing presentation of the one or more content items such that the one or more content items are presented to the user device in a language or a type of currency that is utilized in the geographic location.

17. The method as recited in claim 16, wherein dynamically customizing presentation of the one or more content items includes presenting the one or more content items and any description associated with the one or more content items in the language that is utilized in the geographic location.

18. The method as recited in claim 16, wherein dynamically customizing presentation of the one or more content items includes offering the one or more content items at rates in the type of currency that is utilized in the geographic location.

19. The method as recited in claim 16, further comprising:
detecting a current geographic location of the user device; and
presenting the one or more content items to the user device in a language or a type of currency that is utilized in the current geographic location.

20. The method as recited in claim 16, wherein:
the one or more content items are games; and
a language and a type of currency associated with the games are customized for each of the plurality of user devices that such that a single site is used by the plurality of devices to interact with the games.
